(19) United States
(12) Patent Application Publication
(10) Pub. No.: US 2010/0035648 A1
(43) Pub. Date: Feb. 11, 2010

(54) EARPLUG WITH ALARM AND ELECTRONIC DEVICE SYSTEM WITH SAME

(75) Inventor: YU-CHE HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/506,268

(22) Filed: Jul. 21, 2009

(30) Foreign Application Priority Data
Aug. 11, 2008 (CN) 200810303664.X

(51) Int. Cl. G08B 1/08; H04M 1/00

(52) U.S. Cl. 455/556.1; 340/539.11

(57) ABSTRACT

An electronic device system includes an electronic device and an earplug. The electronic device includes an alarm set module for setting an alarm time according to a user instruction; a clock module for timing and outputting a current time; a process module for comparing the current time with the alarm time, and generating an alarm signal when the current time reaches the alarm time; and a wireless transmission module for receiving the alarm signal and transmitting a corresponding wireless signal. The earplug includes a wireless receiver module for receiving the wireless signal; a control module for generating awake-up signal in response to the wireless signal; and an alarm module for generating an alarm upon receiving the wake-up signal. The electronic device system can be used to awaken a person in a noisy environment.

### BACKGROUND

1. Technical Field

The present disclosure relates to an earplug with an alarm, and to an electronic device system such as a mobile phone system which utilizes the earplug.

2. Description of Related Art

Electronic devices with alarm clock functions, such as mobile phones, are commonly used to awaken people. However, if someone sleeps in a noisy place they may use earplugs to protect themselves from the surrounding noise. In such circumstances, the alarm clock function of the electronic device may be useless because of the earplugs.

Therefore, what is needed is an alarm means which can solve the above-described problems.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an illustrative schematic showing an electronic device system according to an exemplary embodiment.

FIG. 2 is a block diagram of the electronic device system of FIG. 1.

FIG. 3 is a diagrammatic view of an earplug of the electronic device system of FIG. 1.

### DETAILED DESCRIPTION

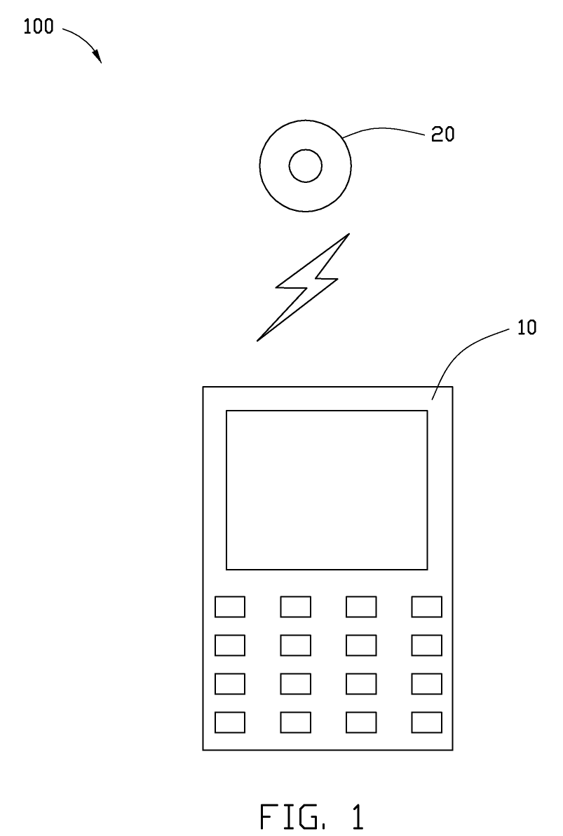

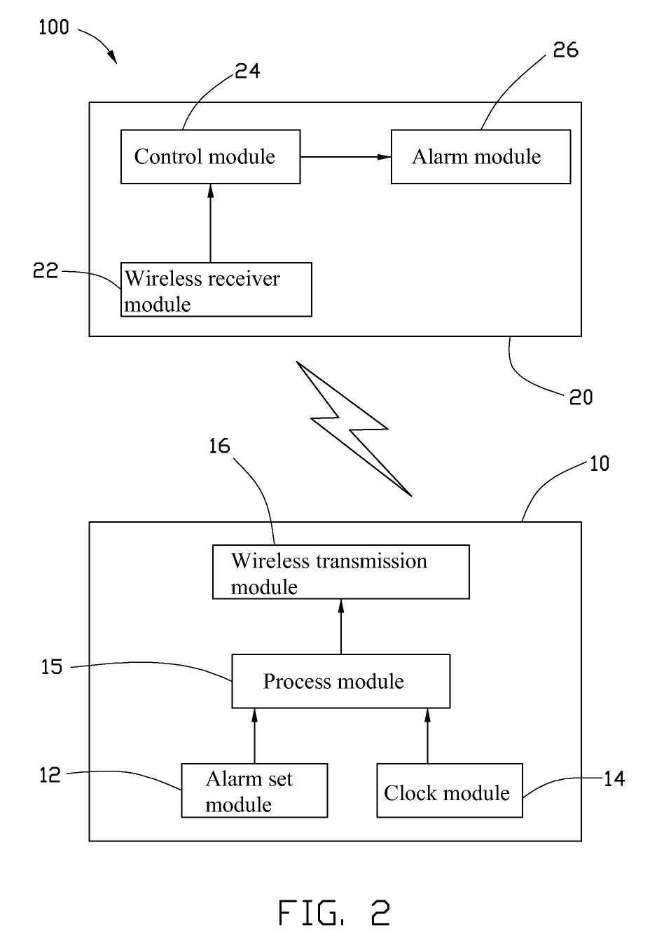

Referring to FIGS. 1 and 2, an electronic device system 100 according to an exemplary embodiment is shown. The electronic device system 100 includes an electronic device 10 and an earplug 20. The electronic device 10 can be any suitable device such as a desktop computer or a portable electronic device. The portable electronic device can for example be a handheld computer such as a personal digital assistant, or a mobile phone. In this embodiment, the electronic device 10 is a mobile phone 10. The mobile phone 10 includes an alarm set module 12, a clock module 14, a process module 15, and a wireless transmission module 16.

The alarm set module 12 is configured (i.e. structured and arranged) for setting an alarm time. A user can access the alarm set module 12 via keys of the mobile phone 10 and set the alarm time as desired.

The clock module 14 is configured for timing, and outputting the current time to the process module 15.

The process module 15 compares the current time with the preset alarm time, and sends an alarm signal to the wireless transmission module 16 when the current time reaches the preset alarm time.

The wireless transmission module 16 receives the alarm signal, and transmits a corresponding wireless signal to the earplug 20. The wireless signal includes a first identification code for identifying the mobile phone 10 as distinct from other mobile phones.

The earplug 20 includes a wireless receiver module 22, a control module 24, and an alarm module 26. The earplug 20 is configured for inserting into a user's ear, to insulate the user from surrounding noise.

The wireless receiver module 22 is configured for receiving the wireless signal transmitted by the wireless transmission module 16, generating a corresponding signal, and transmitting the corresponding signal to the control module 24.

The control module 24 stores a second identification code. The second identification code is used for identifying the mobile phone 10 of the electronic system 100 as distinct from other mobile phones. The second identification code is set by the producer of the earplug 20, and can be reset by the mobile phone 10. When an earplug 20 is assigned to a mobile phone 10 for the first time, a user can access the process module 15 via keys of the mobile phone 10 and set the second identification code. The set second identification code is transmitted to the control module 24 through the wireless transmission module 16 and the wireless receiver module 22, and then the control module 24 changes an original second identification code to the set second identification code.

When the control module 24 receives the above-described corresponding signal generated by the wireless receiver module 22, the control module 24 compares the first identification code of the corresponding signal with the second identification code, and generates a wake-up signal when the first identification code matches the second identification code.

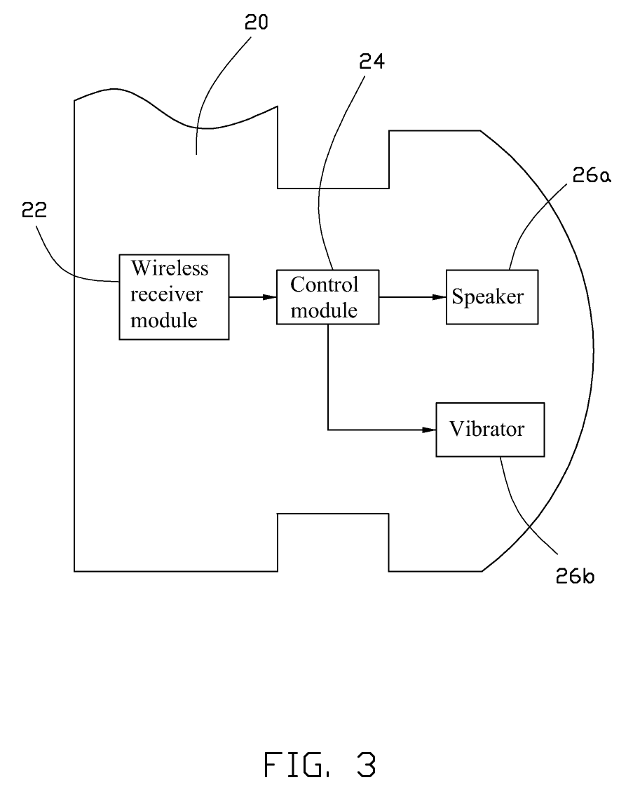

The alarm module 26 generates an alarm according to the wake-up signal, to wake up the user. Referring to FIG. 3, the alarm module 26 can include a speaker 26a, a vibrator 26b, or both of these. Accordingly, the alarm can for example be in the form of sound, vibration, or both of these. In a preferred embodiment, the alarm module 26 is configured such that the frequency of the sound is necessarily within a predetermined range safe for the human ear, and such that a maximum possible volume of the sound is lower than a predetermined threshold amount at which damage may occur to the human ear. Furthermore, the alarm module 26 is configured such that a maximum possible amount of vibration is lower than a predetermined threshold amount at which damage may occur to the human ear. In other words, the alarm module 26 is configured so that any form of the alarm cannot damage the human ear.

The wireless transmission module 16 and the wireless receiver module 22 may be any suitable type, such as short range wireless communication devices (e.g. Bluetooth™ devices) or infrared devices.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An earplug comprising:
a wireless receiver module configured for receiving a wireless signal, wherein the wireless signal comprises a first identification code;
a control module storing a second identification code, wherein the control module is configured for comparing the first identification code with the second identification code, and generating a wake-up signal when the first identification code matches the second identification code; and
an alarm module configured for generating an alarm upon receiving the wake-up signal.

2. The earplug of claim 1, wherein the wireless receiver module comprises a short range wireless communication device.

3. The earplug of claim 1, wherein the wireless receiver module comprises an infrared device.

4. The earplug of claim 1, wherein the alarm is at least one of a vibration alarm and an audible alarm.

5. The earplug of claim 4, wherein a maximum possible amount of vibration which the vibration alarm can generate is lower than a predetermined threshold amount at which damage may occur to the human ear.

6. The earplug of claim 4, wherein the frequency of sound which the audible alarm can generate is within a predetermined range safe for the human ear, and a maximum possible volume of the sound which the audible alarm can generate is lower than a predetermined threshold amount at which damage may occur to the human ear.

7. An electronic device system comprising:
an electronic device comprising:
an alarm set module capable of setting an alarm time according to a user instruction;
a clock module configured for timing and outputting a current time;
a process module configured for comparing the current time with the alarm time, and generating an alarm signal when the current time reaches the alarm time; and
a wireless transmission module configured for receiving the alarm signal and transmitting a corresponding wireless signal; and
an earplug comprising:
a wireless receiver module configured for receiving the wireless signal and generating a corresponding signal;
a control module configured for generating a wake-up signal in response to the corresponding signal; and
an alarm module configured for generating an alarm upon receiving the wake-up signal.

8. The electronic device system of claim 7, wherein the wireless signal comprises a first identification code, the control module stores a second identification code, and the control module is further configured for comparing the first identification code with the second identification code, and generating the wake-up signal when the first identification code matches the second identification code.

9. The electronic device system of claim 7, wherein the wireless transmission module and the wireless receiver module comprise short range wireless communication devices.

10. The electronic device system of claim 7, wherein the wireless transmission module and the wireless receiver module comprise infrared devices.

11. The electronic device system of claim 7, wherein the alarm is at least one of a vibration alarm and an audible alarm.

12. The electronic device system of claim 11, wherein a maximum possible amount of vibration which the vibration alarm can generate is lower than a predetermined threshold amount at which damage may occur to the human ear.

13. The electronic device system of claim 11, wherein the frequency of sound which the audible alarm can generate is within a predetermined range safe for the human ear, and a maximum possible volume of the sound which the audible alarm can generate is lower than a predetermined threshold amount at which damage may occur to the human ear.

14. A mobile phone system comprising:
a mobile phone comprising:
an alarm set module capable of setting an alarm time according to a user instruction;
a clock module configured for timing and outputting a current time;
a process module configured for comparing the current time with the alarm time, and generating an alarm signal when the current time reaches the alarm time; and
a wireless transmission module configured for receiving the alarm signal and transmitting a corresponding wireless signal; and
an earplug comprising:
a wireless receiver module configured for receiving the wireless signal and generating a corresponding signal;
a control module configured for generating a wake-up signal in response to the corresponding signal; and
an alarm module configured for generating an alarm upon receiving the wake-up signal.

15. The mobile phone system of claim 14, wherein the wireless signal comprises a first identification code, the control module stores a second identification code, and the control module is further configured for comparing the first identification code with the second identification code, and generating the wake-up signal when the first identification code matches the second identification code.

16. The mobile phone system of claim 14, wherein the wireless transmission module and the wireless receiver module comprise short range wireless communication devices.

17. The mobile phone system of claim 14, wherein the wireless transmission module and the wireless receiver module comprise infrared devices.

18. The mobile phone system of claim 14, wherein the alarm is at least one of a vibration alarm and an audible alarm.

19. The mobile phone system of claim 18, wherein a maximum possible amount of vibration which the vibration alarm can generate is lower than a predetermined threshold amount at which damage may occur to the human ear.

20. The mobile phone system of claim 18, wherein the frequency of sound which the audible alarm can generate is within a predetermined range safe for the human ear, and a maximum possible volume of the sound which the audible alarm can generate is lower than a predetermined threshold amount at which damage may occur to the human ear.
